(19) United States
(12) Patent Application Publication
(10) Pub. No.: US 2007/0134545 A1
(43) Pub. Date: Jun. 14, 2007

(54) MEMBRANE ELECTRODE ASSEMBLY FOR FUEL CELLS AND FABRICATION METHOD THEREOF

(76) Inventors: Feng-Yi Deng, Taipei (TW); Kuen-Sheng Shen, Taipei (TW); Tz-Lung Yu, Taipei (TW)

Correspondence Address: G. LINK CO., LTD., 3550 BELL ROAD, MINOOKA, IL, 60447, US

(21) Appl. No.: 11/608,918

(22) Filed: Dec. 11, 2006

(30) Foreign Application Priority Data
Dec. 12, 2005 (TW) 094143785

(51) Int. Cl. H01M 4/94; H01M 8/10; B05D 5/12; H01M 4/88

(52) U.S. Cl. 429/44; 429/30; 429/42; 502/101; 427/115

(57) ABSTRACT

The invention proposes a membrane electrode assembly of a fuel cell and its fabrication method thereof. The membrane electrode assembly comprises: a proton exchange membrane; an anode layer that is disposed on a surface of the proton exchange membrane; a first cathode catalyst layer comprising at least one hydrophobic material that is disposed on the other surface of the proton exchange membrane; a second cathode catalyst layer comprising at least one hydrophilic material that is disposed on the surface of the first cathode catalyst layer; a cathode micro-porous layer that is disposed on the surface of the second cathode catalyst layer, and a cathode gas diffusion layer that is disposed on the surface of the cathode micro-porous layer.

### FIELD OF THE INVENTION

The invention relates to a membrane electrode assembly of a fuel cell and its fabrication method thereof, and more particularly, the invention relates to a multi-layered membrane electrode assembly of a fuel cell and fabrication method thereof.

### BACKGROUND OF THE INVENTION

A fuel cell is an electricity-generating device that converts the chemical energy stored in fuel and an oxidizing agent into electrical energy via electrode reaction. There are many different types of fuel cells, and many different methods for classifying the fuel cells. If classification is made on the basis of the electrolytes contained in the cell, the fuel cells can be divided into five different types of fuel cells, which are the alkaline fuel cell, the phosphoric acid fuel cell, the proton exchange membrane fuel cell, the molten carbonate fuel cell, and the solid oxide fuel cell. In the category of the proton exchange membrane fuel cell, it includes the so called direct methanol fuel cell, which directly utilizes methanol as the fuel without having to transform it into oxygen first. The direct methanol fuel cell is one of the recently developed technologies capable of producing higher amounts of energy, and is applied to larger power plants, generators for automobiles, and portable power supplies.

FIG. 1 shows the sectional view of a membrane electrode assembly for a fuel cells according to the prior art. Although the underlying mechanisms of different types of fuel cells vary from one another, the basic mechanism for generating power is universal in all types of fuel cells. In a fuel cell, the anode layer 10 is supplied with fuels continuously, and the cathode layer 12 is supplied with air or oxygen continuously; after the fuel is injected into the anode layer 10 and reacts with the anode catalyst layer 100 to release electrons and ions, the electrons then travel through the external load and reach the cathode layer 12, and subsequently enter chemical reactions with the oxygen and ions which have passed through the electrolyte 14. In fuel cells of prior arts, the cycling of the air or oxygen at the cathode layer 12 is usually achieved by fans or compressors. In some of the fuel cells (for example, the proton exchange membrane fuel cell and the direct methanol fuel cell), fans are installed for a further purpose other than cycling the air; fans can also dispose of the excessive water from cathodes, thus preventing excessive water from impeding the entry of oxygen into the cathode catalyst layer 120 and the consequent diminished performance of the cathode layer 12. Currently, the heat cycling or heat management of fuel cells is an important issue to the industry, and the usual solution is achieved by increasing the number of fans or raising the rotation speed of fans.

To solve the problems described above, the prior arts were focused on developing fan cycling systems with even higher rotation speeds, but neglected another related problem, which is dehydration. There is only one cathode catalyst layer 120 in the cathode layer 12 of the membrane electrode assembly from previous fuel cells, and the cathode catalyst layer 120 is usually made of platinum and hydrophobic polymeric materials (such as polytetrafluoroethylene). The cathode catalyst layer 120, which is already hydrophobic, loses water even more rapidly in the presence of fans with ever stronger air cycling capacity, and thus leading to dehydration. Furthermore, because the ions that pass through the electrolyte 14 are usually transferred to the cathode catalyst layer 120 along with water molecules, ion conductivity could be lowered if the cathode catalyst layer 120 does not retain an adequate amount of water, which consequently causes the overall performance of the fuel cell to decline due to insufficient chemical reaction between water and oxygen.

Therefore, the invention proposes a membrane electrode assembly of a fuel cell and its fabrication method thereof, which aims to address the disadvantages of the prior arts.

### SUMMARY OF THE INVENTION

The main objective of the invention is to propose a membrane electrode assembly of a fuel cell and its fabrication method thereof, which solves the problem of dehydrated cathode catalyst layer, resulting from excessive air flow in the prior arts.

Another objective of the invention is to propose a membrane electrode assembly of a fuel cell and its fabrication method thereof, which allows the cathode catalyst layer to retain adequate amount of water without impeding entry of oxygen into the cathode catalyst layer, or lowering the ion conductivity.

To achieve the objectives described above, the invention discloses a membrane electrode assembly of a fuel cell and its fabrication method thereof. The membrane electrode assembly comprises: a proton exchange membrane; an anode layer that is disposed on a surface of the proton exchange membrane; a first cathode catalyst layer comprising at least one hydrophobic material that is disposed on the other surface of the proton exchange membrane; a second cathode catalyst layer comprising at least one hydrophilic material that is disposed on the surface of the first cathode catalyst layer; a cathode micro-porous layer that is disposed on the surface of the second cathode catalyst layer, and a cathode gas diffusion layer that is disposed on the surface of the cathode micro-porous layer.

### BRIEF DESCRIPTION OF THE DRAWINGS

The foregoing aspects, as well as many of the attendant advantages and features of this invention will become more apparent by reference to the following detailed description, when taken in conjunction with the accompanying drawings, wherein:

FIG. 1 shows the sectional view of a membrane electrode assembly for a fuel cell according to the prior art;

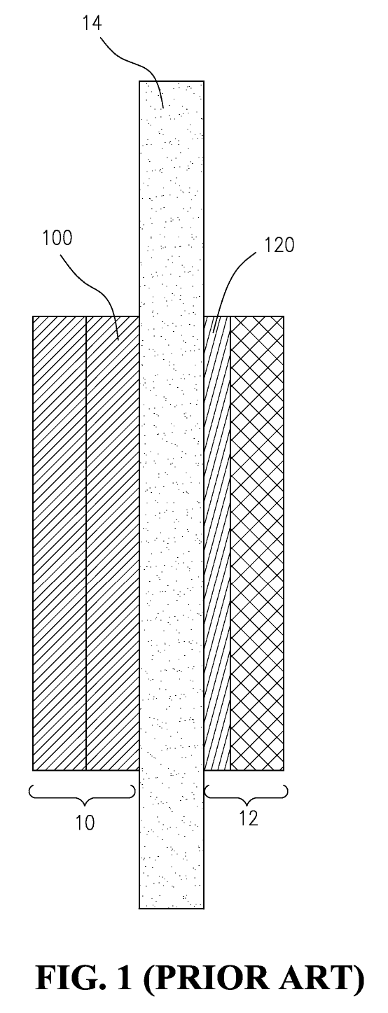

FIG. 2A shows the sectional view of a membrane electrode assembly for a fuel cell according to the invention;

FIG. 2B shows the exploded view of the membrane electrode assembly for a fuel cell in FIG. 2A;

FIG. 3 shows a method for fabricating the membrane electrode assembly for a fuel cell in FIG. 2A according to the invention; and

FIG. 4 shows another method for fabricating the membrane electrode assembly for a fuel cell in FIG. 2A according to the invention.

### DETAILED DESCRIPTION OF THE INVENTION

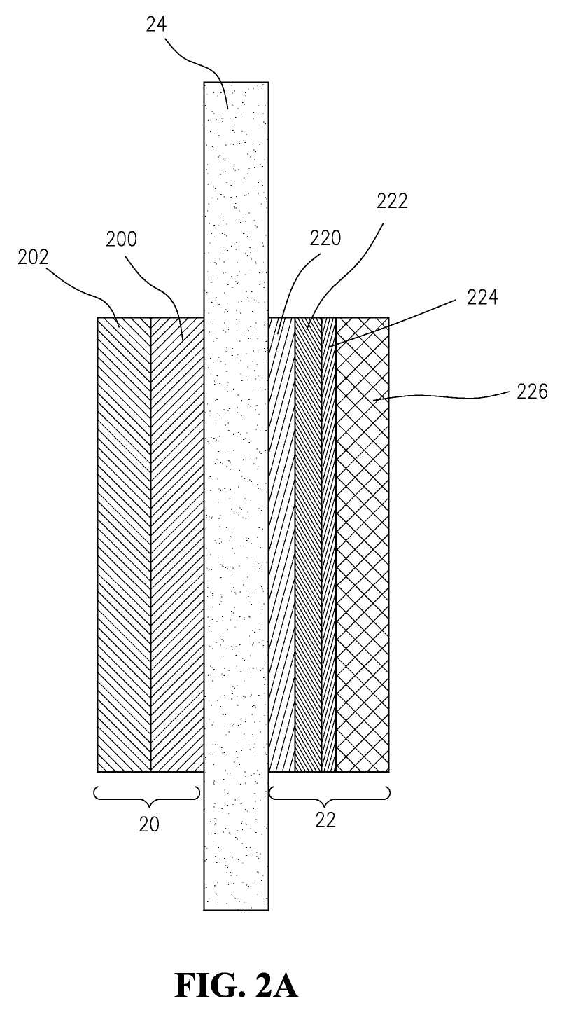

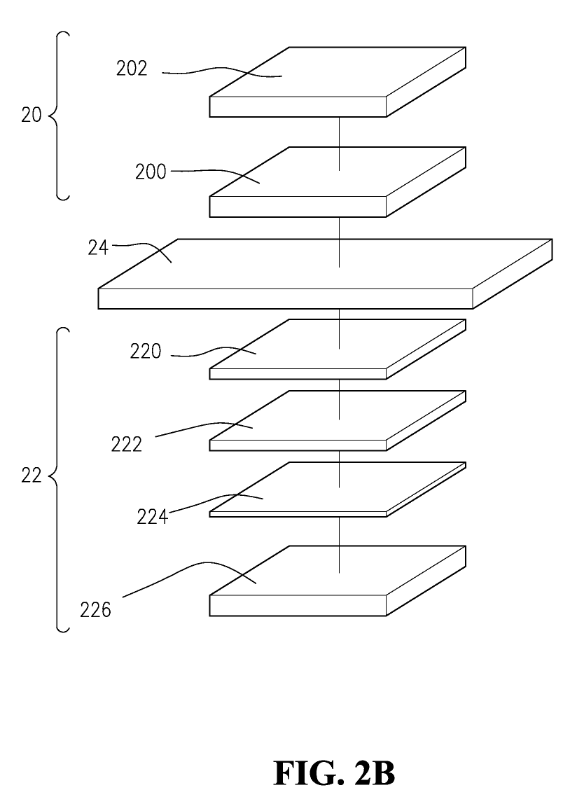

FIG. 2A shows the sectional view of a membrane electrode assembly for a fuel cell according to the invention, and FIG. 2B shows the exploded view of the membrane electrode assembly for a fuel cell in FIG. 2A. The membrane electrode assembly of the invention comprises: a proton exchange membrane 24, an anode layer 20, a first cathode catalyst layer 220, a second cathode catalyst layer 222, a cathode micro-porous layer 224, and a cathode gas diffusion layer 226. The anode layer 20 is disposed on a surface of the proton exchange membrane 24, and the anode layer 20 is further comprised of: an anode catalyst layer 200 serving as the catalyst for electrochemical reactions occurring at the anode of the fuel cell, and an anode gas diffusion layer 202 that is disposed on the surface of the anode catalyst layer 200. The first cathode catalyst layer 220 is disposed on the other surface of the proton exchange membrane 24, and the first cathode catalyst layer 220 comprises at least one hydrophobic material; the second cathode catalyst layer 222 is disposed on the surface of the first cathode catalyst layer 220, and the second cathode catalyst layer 222 comprises at least one hydrophilic material; the cathode micro-porous layer 224 is disposed on the surface of the second cathode catalyst layer 222, and the cathode micro-porous layer 224 comprises at least one hydrophobic material; the cathode gas diffusion layer 226 disposed on the surface of the cathode micro-porous layer 224. The first cathode catalyst layer 220, the second cathode catalyst layer 222, the cathode micro-porous layer 224, and the cathode gas diffusion layer 226 constitute the cathode layer 22 of the membrane electrode assembly.

The materials constituting each of the components of FIG. 2A are described in detail in the following paragraphs. Referring to FIG. 2A, the proton exchange membrane 24 is made from a polymeric material selected from a group consisting of Nafion membrane, and/or perfluorinated sulfonic acid resin, and/or sulfonated polyether ether ketone. The first cathode catalyst layer 220 is at least comprised of platinum (Pt) and one of the hydrophobic materials including polytetrafluoroethylene, copolymers of tetrafluoroethylene and polyvinylidene fluoride, and polyvinylidene fluoride. The second cathode catalyst layer 222 is at least comprised of platinum (Pt) and one of the hydrophilic materials including perfluorinated sulfonic acid resin and sulfonated polyether ether ketone. The cathode micro-porous layer 224 is at least comprised of carbon particles and a hydrophobic material including polytetrafluoroethylene, copolymers of tetrafluoroethylene and polyvinylidene fluoride, and polyvinylidene fluoride. The cathode gas diffusion layer 226 is made of a conductive and porous material. The anode catalyst layer 200 is at least comprised of a polymeric material having hydrogen-ion conductivity and one of the metals including platinum (Pt), ruthenium (Ru), and platinum/ruthenium alloy.

The preferred sizes and materials of each of the components in FIG. 2A will be further disclosed hereafter. Referring to FIG. 2A, the second cathode catalyst layer 222 is 0.025˜0.1 mm in thickness; the cathode micro-porous layer 224 is 0.025˜0.1 mm in thickness, and the anode catalyst layer 200 is 0.05˜0.2 mm in thickness. In addition, for the components of the first cathode catalyst layer 220, the weight percentage of platinum (Pt) is 70˜90 wt %, and the concentration of the hydrophobic materials (for example, polytetrafluoroethylene, copolymers of tetrafluoroethylene and polyvinylidene fluoride, or polyvinylidene fluoride) is 10˜30%. For the components of the second cathode catalyst layer 222, the weight percentage of platinum (Pt) is 70˜90 wt %, and the concentration of the hydrophilic materials (for example, perfluorinated sulfonic acid resin and sulfonated polyether ether ketone) is 101˜30 wt %.

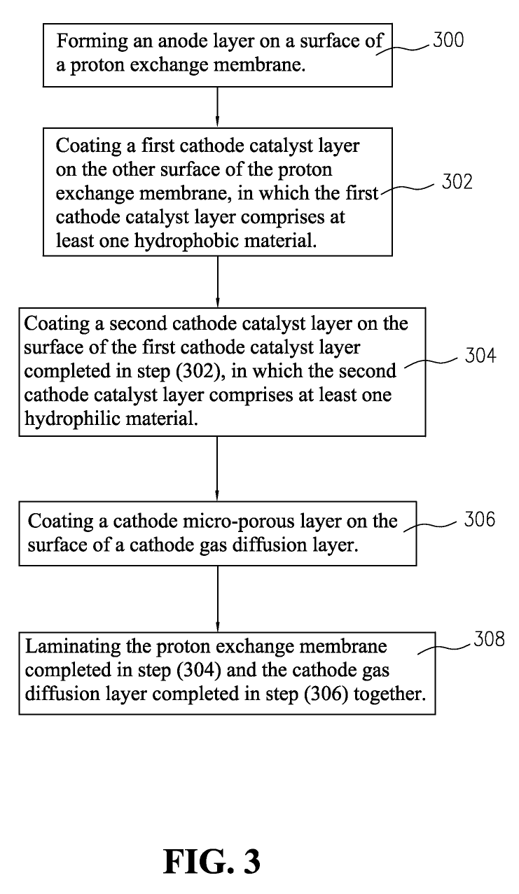

FIG. 3 shows a method for fabricating the membrane electrode assembly for a fuel cell in FIG. 2A according to the invention. The method for fabricating the membrane electrode assembly of the invention comprises step 300, step 302, step 304, step 306, and step 308, which are separately described as below. With reference to FIG. 2A, an anode layer 20 is formed on a surface of the proton exchange membrane 24 in step 300. A first cathode catalyst layer 220 is coated on the other surface of the proton exchange membrane 24 in step 302, wherein the first cathode catalyst layer 220 comprises at least one hydrophobic material. A second cathode catalyst layer 222 is coated on the surface of the first cathode catalyst layer 220 completed in step 302, wherein the second cathode catalyst layer 222 comprises at least one hydrophilic material. After completing steps 300 to 304, the semi-finished membrane electrode assembly is comprised of the anode layer 20, the proton exchange membrane 24, the first cathode catalyst layer 220, and the second cathode catalyst layer 222 from top to bottom. Subsequently, a cathode micro-porous layer 224 is coated on the surface of the cathode gas diffusion layer 226 in step 306, then the proton exchange membrane completed in step 304 and the cathode gas diffusion layer completed in step 306 are laminated together in step 308. The laminating process in step 308 is carried out as a hot pressing procedure at 100˜130° C. and lasts for 1 to 3 minutes in this invention. Moreover, in order to elevate the quality of the membrane electrode assembly of the invention, step 306 described above can further comprise a step in which the cathode micro-porous layer 224 formed on the surface of the cathode gas diffusion layer 226 is sintered at 300˜350° C.

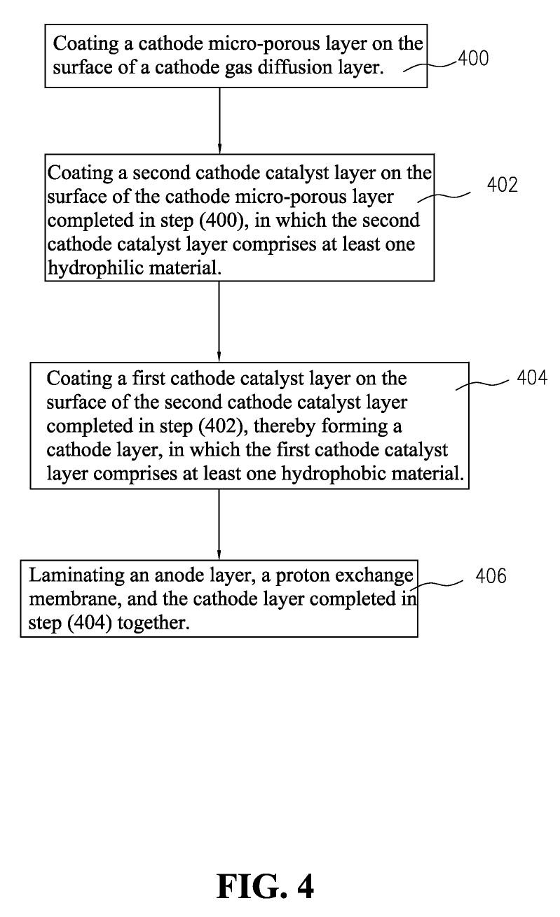

FIG. 4 shows another method for fabricating the membrane electrode assembly for a fuel cell in FIG. 2A according to the invention. This method for fabricating the membrane electrode assembly of the invention comprises step 400, step 402, step 404, and step 406, which are separately described as below. With reference to FIG. 2A, a cathode micro-porous layer 224 is coated on the surface of the cathode gas diffusion layer 226 in step 400. In step 402, a second cathode catalyst layer 222 is coated on the surface of the cathode micro-porous layer 224 completed in step 400, wherein the second cathode catalyst layer 222 comprises at least one hydrophilic material. In step 404, a first cathode catalyst layer 220 is coated on the surface of the second cathode catalyst layer 222 completed in step 402, thereby forming a cathode layer 22, wherein the first cathode catalyst layer 220 comprises at least one hydrophobic material. In step 406, the anode layer 20, the proton exchange membrane 24, and the cathode layer 22 completed in step 404 are laminated together. This method for fabricating the membrane electrode assembly of the invention can further comprise a step in which an anode layer 20 is formed by coating the anode catalyst layer 200 on the surface of the anode gas diffusion layer 202. In addition, the laminating process in step 406 is a hot pressing procedure at 120˜135° C. and lasts for 1 to 3 minutes in this invention. Moreover, in order to elevate the quality of the membrane electrode assembly of the invention, step 400 described above can further comprise a step in which the cathode micro-porous layer 224 formed on the surface of the cathode gas diffusion layer 226 is sintered at 300˜350° C.

In the invention, the proposed membrane electrode assembly has a multi-layered cathode, in which different degrees of surface tension are created due to the varied levels of hydrophobicity at the hydrophobic first cathode catalyst layer 220 and the cathode micro-porous layer 224; as a result, water is retained at the hydrophilic second cathode catalyst layer 222, which in turn lowers the diffusion rate of water at the cathode layer 22 and prevents water from rapidly escaping.

While the invention has been particularly shown and described with reference to the preferred embodiments described above, these are merely examples to help clarify the invention and are not intended to limit the invention. It will be understood by those skilled in the art that various changes, modifications, and alterations in form and details may be made therein without departing from the spirit and scope of the invention, as set forth in the following claims.

What is claimed is:

1. A membrane electrode assembly for a fuel cell comprising:
a proton exchange membrane;
an anode layer being disposed on a surface of said proton exchange membrane;
a first cathode catalyst layer comprising at least one hydrophobic material being disposed on the other surface of said proton exchange membrane;
a second cathode catalyst layer comprising at least one hydrophilic material being disposed on the surface of said first cathode catalyst layer;
a cathode micro-porous layer being disposed on the surface of said second cathode catalyst layer; and
a cathode gas diffusion layer being disposed on the surface of said cathode micro-porous layer.

2. The membrane electrode assembly of claim 1, wherein the proton exchange membrane is made from a polymeric material selected from a group consisting of Nafion membrane, and/or perfluorinated sulfonic acid resin, and/or sulfonated polyether ether ketone.

3. The membrane electrode assembly of claim 1, wherein the cathode micro-porous layer comprises at least one hydrophobic material.

4. The membrane electrode assembly of claim 1, wherein the first cathode catalyst layer is at least comprised of platinum (Pt) and one of the hydrophobic materials including polytetrafluoroethylene, copolymers of tetrafluoroethylene and polyvinylidene fluoride, and polyvinylidene fluoride.

5. The membrane electrode assembly of claim 1, wherein the second cathode catalyst layer is at least comprised of platinum (Pt) and one of the hydrophilic materials including perfluorinated sulfonic acid resin and sulfonated polyether ether ketone.

6. The membrane electrode assembly of claim 3, wherein the cathode micro-porous layer is at least comprised of carbon particles and one of the hydrophobic materials including polytetrafluoroethylene, copolymers of tetrafluoroethylene and polyvinylidene fluoride, and polyvinylidene fluoride.

7. The membrane electrode assembly of claim 1, wherein the cathode gas diffusion layer is made of a conductive and porous material.

8. The membrane electrode assembly of claim 1, wherein the anode layer is further comprised of: an anode catalyst layer serving as the catalyst for the electrochemical reactions occurring at the anode of the fuel cell; an anode gas diffusion layer being disposed on the surface of said anode catalyst layer.

9. The membrane electrode assembly of claim 8, wherein the anode catalyst layer is at least comprised of a polymeric material having hydrogen-ion conductivity and one of the metals including platinum (Pt), ruthenium (Ru), and platinum/ruthenium alloy.

10. The membrane electrode assembly of claim 4, wherein the weight percentage of platinum (Pt) is 70˜90 wt %, and the concentration of any of the hydrophobic materials including polytetrafluoroethylene, copolymers of tetrafluoroethylene and polyvinylidene fluoride, and polyvinylidene fluoride is 10˜30 wt %.

11. The membrane electrode assembly of claim 5, wherein the weight percentage of platinum (Pt) is 70˜90 wt %, and the concentration of any of the hydrophilic materials including perfluorinated sulfonic acid resin and sulfonated polyether ether ketone is 10˜30 wt %.

12. The membrane electrode assembly of claim 1, wherein the second cathode catalyst layer is 0.025˜0.1 mm in thickness.

13. The membrane electrode assembly of claim 1, wherein the cathode micro-porous layer is 0.025˜0.1 mm in thickness.

14. The membrane electrode assembly of claim 10, wherein the anode catalyst layer is 0.05˜0.2 mm in thickness.

15. A method for fabricating a membrane electrode assembly for a fuel cell, comprising:
A. forming an anode layer on a surface of a proton exchange membrane;
B. coating a first cathode catalyst layer on the other surface of the proton exchange membrane, wherein said first cathode catalyst layer comprises at least one hydrophobic material;
C. coating a second cathode catalyst layer on the surface of said first cathode catalyst layer formed in step (B), wherein said second cathode catalyst layer comprises at least one hydrophilic material;
D. coating a cathode micro-porous layer on the surface of a cathode gas diffusion layer; and
E. laminating said proton exchange membrane completed in step (C) and said cathode gas diffusion layer completed in step (D) together.

16. The method of claim 15, further comprising: sintering the cathode micro-porous layer formed on the surface of said cathode gas diffusion layer at 300˜350° C.

17. The method of claim 15, wherein the laminating process in step (E) is a hot pressing procedure at 100−130° C. and lasts for 1 to 3 minutes.

18. The method of claim 15, wherein the proton exchange membrane is made from a polymeric material selected from a group consisting of Nafion membranes, and/or perfluorinated sulfonic acid resin, and/or sulfonated polyether ether ketone.

19. The method of claim 15, wherein the cathode micro-porous layer comprises at least one hydrophobic material.

20. The method of claim 15, wherein the first cathode catalyst layer is at least comprised of platinum (Pt) and a hydrophobic material including polytetrafluoroethylene, copolymers of tetrafluoroethylene and polyvinylidene fluoride, and polyvinylidene fluoride.

21. The method of claim 15, wherein the second cathode catalyst layer is at least comprised of platinum (Pt) and a hydrophilic material including perfluorinated sulfonic acid resin and sulfonated polyether ether ketone.

22. The method of claim 19, wherein the cathode micro-porous layer is at least comprised of carbon particles and a hydrophobic material including polytetrafluoroethylene, copolymers of tetrafluoroethylene and polyvinylidene fluoride, and polyvinylidene fluoride.

23. The method of claim 15, wherein the cathode gas diffusion layer is a conductive and porous material.

24. The method of claim 15, wherein the anode layer is further comprised of: an anode catalyst layer serving as the catalyst for the electrochemical reactions occurring at the anode of the fuel cell; an anode gas diffusion layer being disposed on the surface of said anode catalyst layer.

25. The method of claim 24, wherein the anode catalyst layer is at least comprised of a polymeric material having hydrogen-ion conductivity and one of the metals including platinum (Pt), ruthenium (Ru), and platinum/ruthenium alloy.

26. The method of claim 20, wherein the weight percentage of platinum (Pt) is 70˜90 wt %, and the concentration of any of the hydrophobic materials include polytetrafluoroethylene, copolymers of tetrafluoroethylene and polyvinylidene fluoride, and polyvinylidene fluoride is 10˜30 wt %.

27. The method of claim 21, wherein the weight percentage of platinum (Pt) is 70˜90 wt %, and the concentration of any of the hydrophilic materials include perfluorinated sulfonic acid resin and sulfonated polyether ether ketone is 10˜30%.

28. The method of claim 15, wherein the second cathode catalyst layer is 0.0250˜1 mm in thickness.

29. The method of claim 15, wherein the cathode micro-porous layer is 0.0250˜1 mm in thickness.

30. The method of claim 24, wherein the anode catalyst layer is 0.05˜0.2 mm in thickness.

31. A method for fabricating a membrane electrode assembly for a fuel cell, comprising:
A. coating a cathode micro-porous layer on the surface of a cathode gas diffusion layer;
B. coating a second cathode catalyst layer on the surface of the cathode micro-porous layer completed in step (A), wherein said second cathode catalyst layer comprises at least one hydrophilic material;
C. coating a first cathode catalyst layer on the surface of the second cathode catalyst layer completed in step (B), and thus forming a cathode layer, wherein said first cathode catalyst layer comprises at least one hydrophobic material; and
D. laminating an anode layer, a proton exchange membrane, and the cathode layer completed in step (C) together.

32. The method of claim 31, further comprising: coating an anode catalyst layer on the surface of an anode gas diffusion layer, thereby forming the anode layer.

33. The method of claim 31, further comprising: sintering the cathode micro-porous layer formed on the surface of the cathode gas diffusion layer at 300˜350° C.

34. The method of claim 31, wherein the laminating process in step (D) is a hot pressing procedure at 120˜135° C. and lasts for 1 to 3 minutes.
